(19) United States
(12) Patent Application Publication
(10) Pub. No.: US 2020/0110655 A1
(43) Pub. Date: Apr. 9, 2020

(54) PROACTIVE DATA PROTECTION ON PREDICTED FAILURES

(71) Applicant: EMC IP Holding Company LLC, Hopkinton, MA (US)

(72) Inventors: John S. Harwood, Paxton, MA (US); Assaf Natanzon, Tel Aviv (IL)

(21) Appl. No.: 16/155,806

(22) Filed: Oct. 9, 2018

(51) Int. Cl. G06F 11/07

(52) U.S. Cl. CPC G06F 11/0793; G06F 11/079; G06F 11/0751

(57) ABSTRACT

One example method includes receiving measurement information concerning the operation of a computing system component, comparing the measurement information to a standard, based on the comparison, determining whether or not the measurement information indicates the presence of an anomaly in the operation of the computing system component, when an anomaly is indicated, generating a prediction, based upon the measurement information, as to when the computing system component is expected to fail, and implementing, prior to failure of the computing system component, a proactive data protection action which protects data associated with the computing system component.

### FIELD OF THE INVENTION

Embodiments of the present invention generally relate to data protection and availability. More particularly, at least some embodiments of the invention relate to systems, hardware, software, computer-readable media, and methods for predicting problems with software and hardware, and then proactively taking action to protect data in an associated data protection environment before the problem actually occurs.

### BACKGROUND

Enterprises generate significant amounts of important data that is typically preserved in some type of data protection environment. Typical data protection environments employ a variety of hardware and software in order to provide data security, access, and availability. While strides have been made in terms of their reliability, the hardware and software nevertheless experience failures from time to time.

In many instances, such hardware and software failures occur unexpectedly. As a result, the availability, and possibly the integrity, of the data in the data protection system may be compromised for a period of time, or permanently. Accordingly, it would be useful to know in advance when a hardware component or software component was going to fail so that appropriate proactive steps could be taken to mitigate, or eliminate, the harm that would result from such a failure.

### BRIEF DESCRIPTION OF THE DRAWINGS

In order to describe the manner in which at least some of the advantages and features of the invention can be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example operating environment for some embodiments of the invention.

FIG. 2 discloses aspects of an example host configuration.

FIG. 3 is a block diagram disclosing aspects of an example system according to some embodiments of the invention.

FIG. 4 is a flow diagram that discloses aspects of some example methods for proactive data protection on predicted failures.

### DETAILED DESCRIPTION OF SOME EXAMPLE EMBODIMENTS

Embodiments of the present invention generally relate to data protection and availability. More particularly, at least some embodiments of the invention relate to systems, hardware, software, computer-readable media, and methods for predicting software and hardware problems and failures, and then proactively taking action before the problem or failure actually occurs.

One approach to the problem of inevitable software and hardware failures might be to implement a scheduler that enables a user to select and implement a policy for making copies of applications. The scheduler might create one copy of the application data on a daily basis, and snapshots may be taken for primary devices every several hours, but would not necessarily deliver application consistency. Another approach might be to use logging to provide rollback to points in time, but this approach may work only for some applications, and may not necessarily be application aware.

Instead of these approaches, a better approach is reflected in example embodiments of the invention which, in general, leverage predicted failures to proactively protect, for example, the assets which are predicted to fail. At least some embodiments of the invention are employed in a data protection environment, although the scope of the invention is not limited to such an environment, nor to any particular environment. More generally, embodiments of the invention can be employed in any environment where it would be useful to be able to predict, at least approximately, when a software component or hardware component was likely to fail.

In general, a machine learning process is used to predict failures in systems long before failures occur. For example, such a machine learning process may use indicators from the inputs/outputs (IOs) to/from a drive to predict when that drive will fail. As another example, the same, or a different, machine learning process can be used to predict failure of software and/or hardware based on key performance indicator values (KPIs) gathered from the machine whose behavior is desired to be predicted. As well, various other events, such as communication network outages, may also be predicted by embodiments of the invention. More particularly, anomaly detection for application telemetry across system components can quickly highlight abnormalities, triggering support events to protect data.

In one example embodiment, a machine learning process, which may be implemented by various components, operates to detect a system or application anomaly. Next, the applications and connected resources potentially impacted by an event with which the anomaly is associated may be identified. In advance of the expected failure, various actions such as movement of a virtual machine (VM) or container may be triggered. Additionally or alternatively, data potentially impacted by the expected failure may be replicated to a remote node that would be unaffected by the failure. Finally, the failing component, whether software or hardware, can then be terminated and repaired or replaced, as applicable.

Advantageously then, embodiments of the invention may provide various benefits and improvements relative to conventional hardware, systems and methods. To illustrate, embodiments of the invention may improve the operation of a computing system, or element of a computing system, by identifying software and hardware anomalies that suggest a possible future failure of the associated software or hardware. With this information, action can be taken that will, for example, help maintain the integrity and availability of data by proactive avoidance or elimination of software and hardware failures. As well, the reliability of the systems associated with the hardware and software may be enhanced since potential problems are identified, addressed, and dealt with, before they actually occur.

A. Aspects of an Example Operating Environment

The following is a discussion of aspects of example operating environments for various embodiments of the invention. This discussion is not intended to limit the scope of the invention, or the applicability of the embodiments, in any way.

Where data protection operations, such as backup and/or restore operations are performed, at least some embodiments may be employed in connection with a data protection environment, such as the Dell-EMC DataDomain environment, which can implement backup, archive, restore, and/or disaster recovery, functions. However, the scope of the invention is not limited to this example data protection environment and extends, more generally, to any data protection environment in connection with which data is created, saved, backed up and/or restored. More generally still, the scope of the invention embraces any operating environment in which the disclosed concepts may be useful.

The data protection environment may take the form of a cloud storage environment, an on-premises storage environment, and hybrid storage environments that include public and private elements, although the scope of the invention extends to any other type of data protection environment as well. Any of these example storage environments, may be partly, or completely, virtualized. The storage environment may comprise, or consist of, a datacenter which is operable to service read and write operations initiated by one or more clients.

In addition to the storage environment, the operating environment may also include one or more host devices, such as clients for example, that each host one or more applications. As such, a particular client may employ, or otherwise be associated with, one or more instances of each of one or more applications. In general, the applications employed by the clients are not limited to any particular functionality or type of functionality. Some example applications and data include email applications such as MS Exchange, filesystems, as well as databases such as Oracle databases, and SQL Server databases, for example. The applications on the clients may generate new and/or modified data that is desired to be protected.

Any of the devices, including the clients, servers and hosts, in the operating environment can take the form of software, physical machines, or virtual machines (VM), or any combination of these, though no particular device implementation or configuration is required for any embodiment. Similarly, data protection system components such as databases, storage servers, storage volumes, storage disks, replication services, backup servers, restore servers, backup clients, and restore clients, for example, can likewise take the form of software, physical machines or virtual machines (VM), though no particular component implementation is required for any embodiment. Where VMs are employed, a hypervisor or other virtual machine monitor (VMM) can be employed to create and control the VMs.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files, contacts, directories, sub-directories, volumes, and any group of one or more of the foregoing.

Example embodiments of the invention are applicable to any system capable of storing and handling various types of objects, in analog, digital, or other form. Although terms such as document, file, block, or object may be used by way of example, the principles of the disclosure are not limited to any particular form of representing and storing data or other information. Rather, such principles are equally applicable to any object capable of representing information.

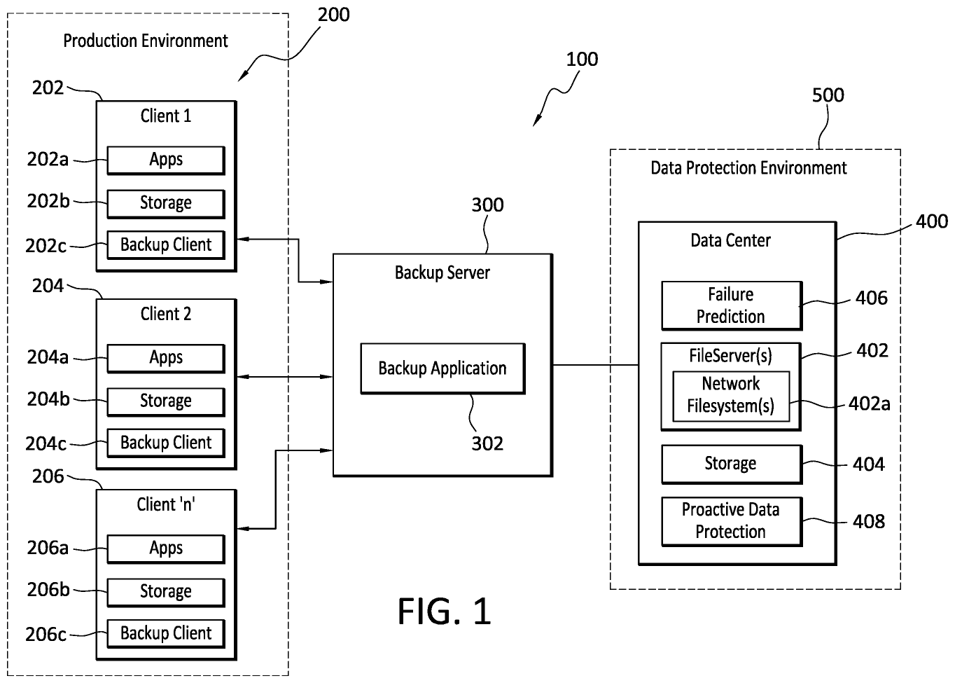

With particular attention now to FIG. 1, an operating environment 100 may include a plurality of clients 200, such as clients 202, 204 and 206. Each of the clients 200 may host one or more applications 202a, 204a and 206a, respectively, that create new and/or modified data that is desired to be protected. As such, the clients 200 are examples of host devices. One, some, or all, of the clients 200 may take the form of a VM, although that is not required. In general, the VM is a virtualization of underlying hardware and/or software and, as such, one or more of the clients 200 may include or otherwise be associated with various underlying components.

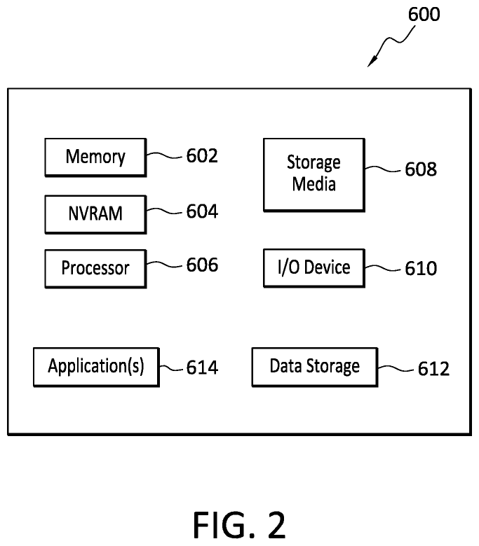

As well, each of the clients 200 may include respective local storage 202b, 204b and 206b. The local storage 202b, 204b and 206b can be used to store data, which may be backed up as described below. The backup data can be restored to local storage 202b, 204b and 206b. The clients 200 may each also include a respective backup client application 202c, 204c and 206c. As shown in FIG. 1, and discussed in connection with FIG. 2, the clients 200 may collectively form a portion of a Production Environment.

With continued reference to FIG. 1, the example operating environment 100 may further include one or more backup servers, such as a backup server 300 that includes a backup application 302. The backup application 302 may cooperate with one or more of the backup clients 202c, 204c, or 206c to backup client 202, 204 and 206 data and/or applications 202a, 204a, and 206a, at a datacenter 400 of a data protection environment 500. The backup application 302 may also cooperate with one or more of the backup clients 202c, 204c, or 206c to restore backed up client 202, 204 and 206 data from the datacenter 400 to the clients 202, 204 and 206. In some embodiments, the backup server 300 may be an EMC Corp. Avamar server or an EMC Corp. Networker server, although no particular server is required for embodiments of the invention.

The data protection environment 500 may be implemented as, or comprise, a Dell-EMC DataDomain data protection environment, although that is not required. As well, the data protection environment 500 may additionally include backup applications and associated hardware and software, such as backup servers for example. Such backup applications may include, for example, EMC Corp. Avamar and EMC Corp. NetWorker.

The data protection environment 500 may support various data protection processes, including data replication, cloning, data backup, and data restoration, for example. As indicated, the data protection environment 500, may comprise or consist of datacenter 400, which may be a cloud storage datacenter in some embodiments, that includes one or more network fileservers 402 that are accessible, either directly or indirectly, by the clients 200. Each of the network fileservers 402 can include one or more corresponding network filesystems 402a, and/or portions thereof.

The datacenter 400 may include and/or have access to storage 404, such as a data storage array for example, that communicates with the network filesystems 402a. In general, the storage 404 is configured to store client 200 data backups that can be restored to the clients 200 in the event that a loss of data or other problem occurs with respect to the clients 200. The term data backups is intended to be construed broadly and includes, but is not limited to, partial backups, incremental backups, full backups, clones, snapshots, continuous replication, and any other type of copies of data, and any combination of the foregoing. Any of the foregoing may, or may not, be deduplicated.

The storage 404 can employ, or be backed by, a mix of storage types, such as Solid State Drive (SSD) storage for transactional type workloads such as databases and boot volumes whose performance is typically considered in terms of the number of input/output operations (IOPS) performed. Additionally, or alternatively, the storage 404 can use Hard Disk Drive (HDD) storage for throughput intensive workloads that are typically measured in terms of data transfer rates such as MB/s.

As shown, the datacenter 400 may also include failure prediction functionality 406, which may be referred to simply as failure prediction 406, and proactive data protection functionality 408, which may be referred to simply as proactive data protection 408. Both failure prediction 406 and proactive data protection 408, in some embodiments, can be implemented as computer executable instructions. In general, and as disclosed herein, the proactive data protection 408 may be operable to perform and/or direct the performance of monitoring hardware and software for anomalies, identifying and flagging anomalies, identifying potentially impacted hardware and software, identifying and implementing proactive actions to be taken in anticipation of the failure of the hardware or software component in connection with which the anomaly was identified. Such monitoring can include taking measurements, such as by way of sensors for example, of various operating parameters of the hardware and/or software whose potential failure is of interest. In some embodiments, one, some, or all, of monitoring, anomaly identification/flagging, impacted hardware and software identification, and failure prediction, may be performed by the failure prediction 406.

In some embodiments, the proactive data protection 408 may reside in a data protection environment 500, such as in the datacenter 400 for example, and the proactive data protection 408 may operate in connection with hardware and software in the datacenter 400. Additionally, or alternatively, one or more instances of the proactive data protection 408 may be employed for the same purpose at any other site where the there is a need to take proactive action in anticipation of a software or hardware failure. For example, an instance of the proactive data protection 408 may be employed in a production environment 200, or in an enterprise on-premises data protection environment.

B. Example Host and Server Configurations

With reference briefly now to FIG. 2, any one or more of the clients 202, backup server 300, file server 402, storage 404, failure prediction 406, proactive data protection 408, and data center 400, can take the form of, or include, a physical computing device, one example of which is denoted at 600. By way of example, the failure prediction 406 functionality may be implemented in a processing server. As well, where any of the aforementioned elements comprise or consist of a virtual machine (VM), that VM may constitute a virtualization of any combination of the physical components disclosed in FIG. 2.

In the example of FIG. 2, the physical computing device 600 includes a memory 602 which can include one, some, or all, of random access memory (RAM), non-volatile random access memory (NVRAM) 604, read-only memory (ROM), and persistent memory, one or more hardware processors 606, non-transitory storage media 608, I/O device 610, and data storage 612. One or more of the memory components 602 of the physical computing device can take the form of solid state device (SSD) storage. As well, one or more applications 614 are provided that comprise executable instructions. Such executable instructions can take various forms including, for example, instructions executable to perform any method or portion thereof disclosed herein, and/or executable by/at any of a storage site, whether on-premised at an enterprise, or a cloud storage site, client, datacenter, or backup server to perform functions disclosed herein in connection with embodiments of the proactive data protection 408. As well, such instructions may be executable to perform any of the other operations disclosed herein including, but not limited to, read, write, backup, and restore operations.

C. Example Proactive Data Protection Operations

In general, embodiments of the invention may perform monitoring and measuring of various hardware and/or software parameters. This monitoring and measuring, which may be referred to as collectively comprising elements of a detection process, may take place at the storage and data protection system. Because of the emphasis on software defined computing systems, integration of the detection process and methods with data protection systems, and network management operations, may be accomplished relatively easily in such software defined computing systems. In contrast with a configuration where, for example, telemetry analysis might be performed at layers, infrastructure, platform, or application, thus leaving external elements to build and execute the proper triggers, embodiments of the inventions may provide for relatively deeper integration between the data protection data management and the system, storage, networking and the failure detection algorithms.

Following is a discussion of some example, but non-limiting, scenarios within the scope of the invention. In general, such scenarios may include, for example, monitoring hardware and/or software, taking measurements of various parameters relating to the operation and performance of the hardware and/or software, making failure predictions based on such measurements, and then implementing one or more proactive actions.

One or more proactive actions may be automatically triggered, and implemented, upon the occurrence of a particular event, such as upon detection of an anomaly, and/or upon generation of a prediction of the failure of a software component or hardware component. In some embodiments, proactive actions may be identified and recommended, and then triggered manually by a user such as an administrator for example. In the following examples, various proactive actions are indicated, but it should be understood that not all proactive actions listed need to be taken, nor do the proactive action(s) necessarily have to be taken in any particular order. As well, parameters associated with a proactive action may change after initiation of the proactive action. For example, if a proactive action is to take backups of a VM, the time between successive VM backups may decrease as the expected failure time comes closer. Put another way, the rate at which VM backups are performed may increase as the time to expected failure decreases. The foregoing is presented only by way of example, and various other parameters associated with a proactive action may be varied as well.

In a first example, proactive data protection may be implemented in connection with a disk drive. Thus, prediction of a failure of the disk drive, based on disk driving monitoring and analysis for example, may cause proactive action(s) to be taken which will increase the availability of data stored on the disk drive. For example, if proactive data protection indicates that the disk drive is expected to fail within a particular time frame, a first action to be taken may be to create a clone of the logical units (LUs) which use the failing disk drive, where the LU can be in the form of software such as an application, or hardware. Example LUs also include any device addressed by the small computer system interface (SCSI) protocol or Storage Area Network (SAN) protocols which encapsulate SCSI, such as Fibre Channel or iSCSI. An LU may also take the form of any device which supports read/write operations, examples of which include tape drives, and SAN logical disks.

After the clone is created, replication of the LU volume to a different site may be automatically initiated. As well, backup scheduling may be changed, in order to create more backup copies for the LUs and/or applications utilizing the disk drive which has been predicted to fail.

A second example scenario involves the implementation of proactive data protection in connection with the prediction of a storage failure. In this example, after a storage failure has been predicted, such as in connection with measurements taken concerning operating parameters of the storage, a first proactive action that may be taken is to trigger the coordinated use of persistent memory to capture transactions, that is, IOs.

Next, processes such as, but not limited to, the snapshot, logging, and replicating of data in persistent memory across failure domains can be managed to account for the predicted failure. For example, these processes can be accelerated so that they are performed sooner than would otherwise be the case. As another example, data replication can be redirected to a node, or nodes, other than the node associated with the failing storage. As a further example, the number of snapshots of data in the failing storage may be increased so as to provide more restore points for the failing storage, and thereby reduce the extent to which data might be lost.

Continuing with the failing storage example scenario, another proactive action that may be taken is that the persistent memory capture may be de-staged to downstream data protection elements in order to provide real time protection of the data in the failing storage. For example, new and/or updated data from the failing storage may be written asynchronously from the failing storage, such as a cache or nonvolatile storage, to a direct access storage device.

A third example scenario involves the implementation of proactive data protection in connection with the prediction of a machine failure or virtual machine (VM) failure. In this example, after a machine or VM failure has been predicted, such as in connection with measurements taken concerning operating parameters of the machine or VM, one proactive action that may be taken is to modify a backup schedule so that the number of machine/VM backups is increased. This approach may help to reduce the amount of data loss in the event that the machine/VM should fail sooner than predicted. For example, if a backup of a VM is taken shortly before a failure occurs, the VM may be able to be restored with little or no data loss. Another proactive action that may be taken is to configure a snapshot of the machine which is expected to fail, so as to reduce the risk of data loss.

A fourth example scenario involves the implementation of proactive data protection in connection with the prediction of a network failure. In this example, one proactive action that can be taken is to modify a backup schedule to increase the likelihood that important applications will be backed up prior to the failure. The backup schedule may be modified in a variety of ways. For example, some actions taken concerning the backup schedule may include stopping creation of new copies of the data at the remote site, and completing transmission of current copies, that is, shipping the last snapshot and backup copy and not continuing so that other applications can complete the backup. Another action that may be taken concerning the backup schedule is to stop backup and replication of less important applications, so as to allow more bandwidth for backup and replication of the current application.

A further example scenario involves the implementation of proactive data protection in connection with the prediction of a system or application failure. In this example, an anomaly, which may be predictive of a system failure or application failure, may have been detected in connection with the operation of the system or application. In this example scenario, various proactive actions may be taken. Such proactive actions may include identifying applications and connected resources expected to be impacted by the failure, triggering movement of VM or container to another storage node or site, replicating data to a remote node, that is, a node other than the node where the failing system or application resides, and terminating the failing components, that is, the system or application in connection with which the anomaly was detected.

The foregoing scenarios are provided only by way of example. Thus, the scope of the invention is not limited to those examples, or to any particular aspect(s) of those examples.

D. Aspects of Example System Architecture

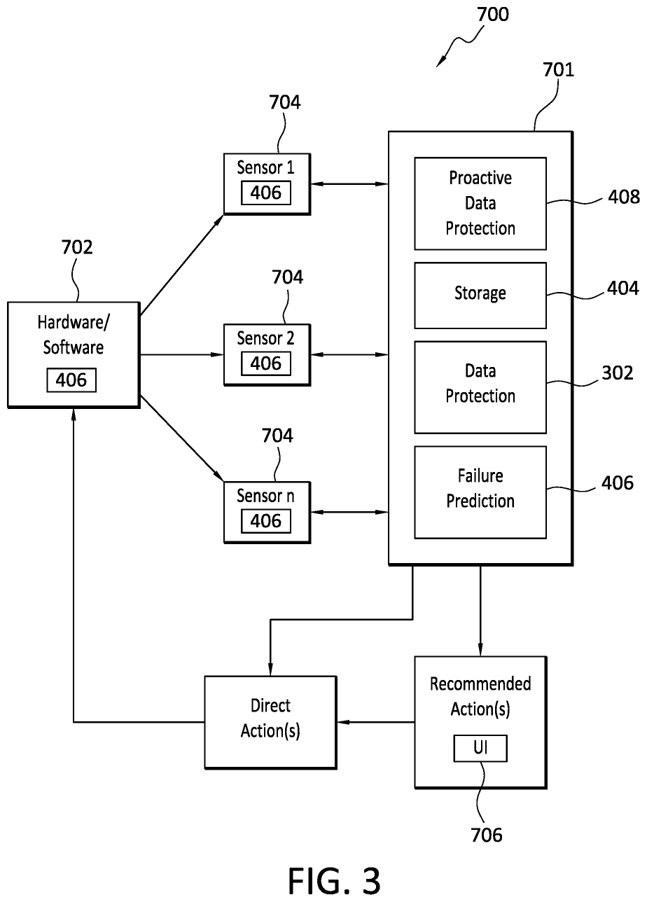

Turning now to FIG. 3, details are provided concerning an example system architecture that may be employed to implement proactive data protection processes. At least some embodiments of a system architecture integrate storage, data protection, and failure prediction. Some embodiments of a system architecture further integrate proactive data protection along with storage, data protection, and failure prediction.

In FIG. 3, one example embodiment of a system architecture is denoted generally at 700. As shown in the example integrated stack 701, the system architecture 700 may provide for the integration of data protection, which may be provided by a backup application 302 in some embodiments, data storage 404, and proactive data protection 408. Note that integration does not necessarily imply that these elements are physically co-located, although they may be in some embodiments. More generally, integration refers to the notion that these elements operate in conjunction, and communicate, with each other. In some embodiments, failure prediction 406 may be integrated with the other aforementioned elements in the integrated stack 701.

As shown, the system architecture 700 may include one or more software components and/or hardware components, collectively denoted at 702, whose operation and performance are of interest in failure prediction and proactive data protection. In order to monitor the performance and operation of the software/hardware components 702, various sensors 704 may be employed. Any type and number of sensors 704 can be used, and any kind of hardware/software operating and performance parameter can be monitored for anomalies. One or more of the sensors 704 may be stand-alone elements or, alternatively, can be integrated within the hardware/software whose performance and operation is being measured by the sensors 704. No particular sensor arrangement or configuration is required.

Both physical, and non-physical, operating and performance parameters may be monitored and measured by the sensors. More generally, any parameter that may provide direct, or inferential, insight as to whether or not hardware or software is operating within an accepted operating standard or performance standard, may be monitored and measured.

For example, physical parameters that may be measured include, solely for the purposes of illustration, central processing unit (CPU) temperature, disk drive motor temperature, disk drive revolutions per minute (RPM), disk drive noise output level, storage element temperature, and disk drive and memory read and write speeds. Some example non-physical parameters that may be measured include, solely for the purposes of illustration, the number of IOs processed by a disk or other memory element, a bit error rate (BER), and the number and timing of application crashes.

As indicated in FIG. 3, the sensors 704 may communicate with an integrated stack, configured as discussed above. Thus configured and arranged, the sensors 704 can measure various parameters of the hardware/software 702 and communicate those measurements to the integrated stack 701, particularly, the failure prediction 406, for analysis. The failure prediction 406 can then analyze the information provided by the sensors to identify any anomalies in the performance or operation of the monitored hardware/software.

This may be done, for example, by comparing the measurements with established standards of acceptable behavior or performance. Any anomalies can then be flagged by the failure prediction 406, and reported such as to a system administrator for example. As well, the anomalies can be mapped by the failure prediction 406 to (i) information such as an expected remaining life for the component for which the anomaly was identified, and may also be mapped to (ii) one or more proactive data protection actions, examples of which are disclosed elsewhere herein. Such a map, which can be updated by a user, may reside, for example, at the failure prediction 406, or elsewhere.

As indicated in the example configuration of FIG. 3, the failure prediction 406 functionality can reside at various sites. For example, the failure prediction 406 functionality may be integrated within the hardware/software 702 whose performance is being monitored and measured. Additionally, or alternatively, the failure prediction 406 functionality may be integrated within the sensors 704. Finally, and as noted earlier, the failure prediction 406 functionality may be implemented within the integrated stack 701. More generally, the failure prediction 406 functionality can be implemented in any suitable system, software or device, and at any suitable site(s). As such, the scope of the invention is not limited to the illustrative examples shown in FIG. 3.

With continued reference to FIG. 3, and as noted, various proactive data protection actions can be taken after an anomaly has been detected. The proactive actions may be mapped to the anomaly and, when determined, can be presented to a user, such as by way of a UI 706, for selection and initiation. Additionally, or alternatively, an entity, such as the proactive data protection 408 for example, may take, and/or direct the taking of, direct proactive data protection action(s) without user input, although a user or system may be notified as to the nature of the proactive data protection action(s), and to the fact that the proactive data protection action has been initiated.

In order to take, or provide for, proactive data protection actions, the proactive data protection 406 may communicate with, and control directly or indirectly, not only the monitored software/hardware, but also the systems and components that implement the proactive data protection actions. Such systems and components can include any of the elements disclosed herein including, but not limited to, any of the elements disclosed in the Figures and/or elsewhere herein. To briefly illustrate, examples of such systems and components may include backup servers, backup applications, storage devices such as disk drives and memory, storage nodes, and storage sites. More generally, any system, application, and/or device, capable of implementing, either in whole or in part, a proactive data protection action, may communicate with, and be controlled directly or indirectly by, the proactive data protection 406.

E. Aspects of Example Methods for Proactive Data Protection

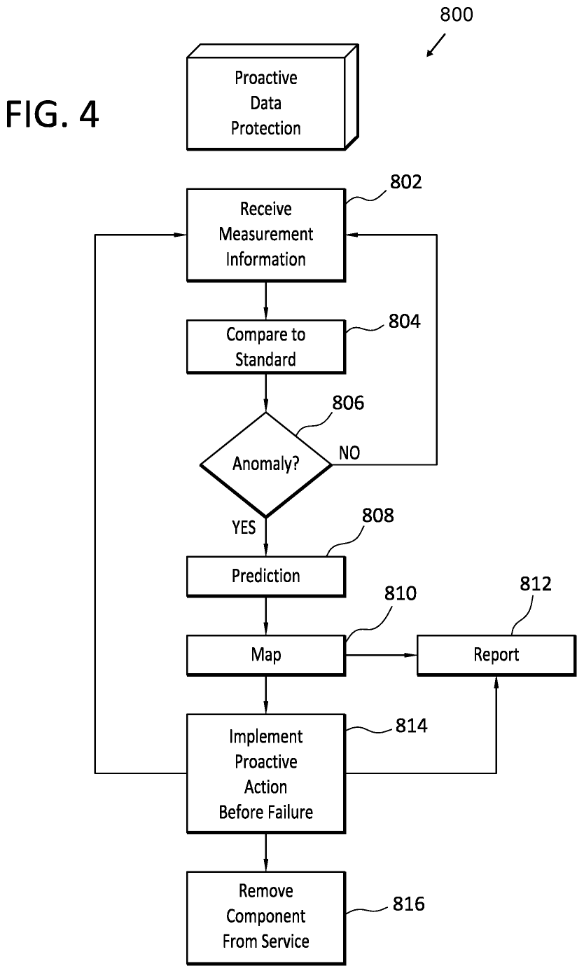

With attention now to FIG. 4, details are provided for some example methods for implementing proactive data protection, where one example embodiment of such a method is denoted generally at 800. The method may be performed in whole or in part by a single entity, or cooperatively by two or more entities, examples of which entities are disclosed herein. In at least some instances, the method may be performed by a proactive data protection module which may reside, for example, at a datacenter or any other data storage site. However, the scope of the invention is not limited to performance of the method at any particular site, or by any particular entity(ies).

The method 800 may begin with monitoring and measuring 802 of the performance and operation of a hardware and/or software component. The monitoring and measuring 802 may be performed on an ad hoc basis, a periodic basis, a continuous basis, or any other basis. The process 802 may involve receiving measurement information from one or more sensors that are in communication with the hardware and/or software component. The measurement information may be pulled from one or more sensors, and/or may be pushed by the sensors, such as to a proactive data protection module.

After the measurement information has been received 802, it can be compared 804 with operational, performance, and/or other standards. Using the results of the comparison as a basis, a determination can be made 806 whether or not an anomaly is present. If it is determined 806 that no anomaly is present, the process 800 may return to 802.

On the other hand, if it is determined that an anomaly is present, the process 800 advances to 808 where the measurement data is processed and used to generate a prediction as to when the monitored component is expected to fail. The prediction 808 can be generated in any of a variety of ways. Some examples of suitable prediction methods and algorithms that can be used in embodiments of the invention, and which can also be used in the measurement process, include, but are not limited to, classification and regression trees, automated machine learning algorithms, disk reliability analyses, and various Bayesian methods.

After the failure prediction has been generated 808, the device and predicted failure can then be mapped 810 to one or more corresponding proactive data protection actions. The mapping 810 may be as simple as identifying one or more proactive data protection actions to be taken, or may be more involved, such as creating a data protection plan involving multiple proactive data protection actions implemented over a period of time, and in a particular relation to each other.

The proactive data protection actions that have been identified can then be reported 812 to a user and/or other entity. In some instances, the user may select, and initiate implementation of, one or more of the proactive data protection actions. In other instances, the identified proactive data protection actions may be automatically implemented 814. During the implementation process, measurements may continue to be received 802, and the nature and timing of the proactive data protection actions that are in-process may be adjusted as required. For example, if the measurements indicate that a disk is failing faster than was predicted, the rate at which backups of the disk are performed, according to a proactive data protection action, may be increased so as to reduce or avoid data loss that may occur if the disk fails sooner than was predicted.

After the proactive data protection actions have been implemented 814, further reporting 812 may follow. For example, a report may be generated and transmitted indicating that the proactive data protection actions have been successfully completed. At this point, the failing component can be disabled, taken off line, or otherwise removed from service 816.

As indicated in FIG. 4, the method 800 may take the form of an open loop process. That is, the measurement information from the monitored component is not used as an input to improve operation, performance, or control of that component. Rather, and as explained above, the measurement information may be used to identify both the need for, and type of, proactive data protection action to be taken.

F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein.

As indicated above, embodiments within the scope of the present invention also include computer storage media, which are physical media for carrying or having computer-executable instructions or data structures stored thereon. Such computer storage media can be any available physical media that can be accessed by a general purpose or special purpose computer.

By way of example, and not limitation, such computer storage media can comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which can be used to store program code in the form of computer-executable instructions or data structures, which can be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ can refer to software objects or routines that execute on the computing system. The different components, modules, engines, and services described herein may be implemented as objects or processes that execute on the computing system, for example, as separate threads. While the system and methods described herein can be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention can be performed in client-server environments, whether network or local environments, or in any other suitable environment. Suitable operating environments for at least some embodiments of the invention include cloud computing environments where one or more of a client, server, or other machine may reside and operate in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method, comprising:
communicating with a sensor, and communicating with the sensor comprises receiving information collected and/or generated by the sensor concerning the operation of a computing system component that is monitored by the sensor;
comparing the information received from the sensor, to a standard;
based on the comparing, determining that the information indicates the presence of an anomaly in the operation of the computing system component;
after the anomaly is indicated, generating a prediction, based upon the indicated anomaly, as to when the computing system component is expected to fail; and
implementing, prior to failure of the computing system component, a proactive data protection action which protects data associated with the computing system component, and the proactive data protection action is performed according to a schedule that assumes the failure of the computing system component will occur sooner than predicted.

2. The method as recited in claim 1, wherein the computing system component comprises a software component and/or a hardware component.

3. The method as recited in claim 1, wherein the proactive data protection action comprises increasing a rate at which the computing system component is backed up.

4. (canceled)

5. The method as recited in claim 1, wherein the proactive data protection action comprises any of: modifying a backup schedule associated with the computing system component; migrating data from the computing system component; creating a backup of the computing system component; creating a snapshot of the computing system component; using persistent memory to capture data transactions involving the computing system component; and, writing data asynchronously from the computing system component to a remote node.

6. The method as recited in claim 1, further comprising mapping the indicated anomaly to one or more corresponding proactive data protection actions, and mapping the indicated anomaly to an expected remaining life of the computing system component.

7. The method as recited in claim 1, wherein the computing system component comprises a virtual machine (VM) and the data concerning which the data protection action is performed comprises virtual machine (VM) data.

8. The method as recited in claim 1, wherein information continues to be received from the sensor during implementation of the proactive data protection action.

9. The method as recited in claim 1, further comprising modifying an aspect of the proactive data protection action as the proactive data protection action is being performed.

10. The method as recited in claim 1, wherein implementation of the proactive data protection action is automatically triggered by a determination that an anomaly is present.

11. A non-transitory storage medium having stored therein instructions which are executable by one or more hardware processors to perform operations comprising:
communicating with a sensor, and communicating with the sensor comprises receiving information collected and/or generated by the sensor concerning the operation of a computing system component that is monitored by the sensor;
comparing the information received from the sensor, to a standard;
based on the comparing, determining that the information indicates the presence of an anomaly in the operation of the computing system component;
after the anomaly is indicated, generating a prediction, based upon the indicated anomaly, as to when the computing system component is expected to fail; and
implementing, prior to failure of the computing system component, a proactive data protection action which protects data associated with the computing system component, and the proactive data protection action comprises any one or more of: stopping creation of new copies of the data and completing transmission of any current copies of the data; and, stopping backup and replication of a first application having a relatively lower backup priority than a backup priority of a second application.

12. The non-transitory storage medium as recited in claim 11, wherein the computing system component comprises hardware and/or software.

13. The non-transitory storage medium as recited in claim 11, wherein the computing system component comprises a communication network component, and when a problem is experienced with the communication network, the operations further comprise pausing a proactive data protection action, and/or waiting for a proactive data protection action to complete before starting another proactive data protection action.

14. (canceled)

15. (canceled)

16. The non-transitory storage medium as recited in claim 11, further comprising mapping the indicated anomaly to one or more corresponding proactive data protection actions.

17. The non-transitory storage medium as recited in claim 11, wherein the operations further comprise, when an anomaly has been detected, removing the failing computing system component from service

18. The non-transitory storage medium as recited in claim 11, wherein information continues to be received from the sensor during implementation of the proactive data protection action.

19. The non-transitory storage medium as recited in claim 11, wherein the operations further comprise modifying an aspect of the proactive data protection action as the proactive data protection action is being performed.

20. The non-transitory storage medium as recited in claim 11, wherein implementation of the proactive data protection action is automatically triggered by a determination that an anomaly is present.
